(19) United States
(12) Patent Application Publication
(10) Pub. No.: US 2005/0188029 A1
(43) Pub. Date: Aug. 25, 2005

(54) Forming a message from information shown on display

(76) Inventors: Pauli Asikainen, Lempaala (FI); Petteri Kallio, Tampere (FI)

Correspondence Address: CRAWFORD MAUNU PLLC, 1270 NORTHLAND DRIVE, SUITE 390, ST. PAUL, MN, 55120, US

(21) Appl. No.: 11/009,203

(22) Filed: Dec. 9, 2004

(30) Foreign Application Priority Data
Dec. 18, 2003 (FI) 20031859

(51) Int. Cl. G06F 15/16

(52) U.S. Cl. 709/206; 709/245

(57) ABSTRACT

A method of forming a message from information contents shown on a display, wherein information contents associated with at least one file or information flow are shown, opened, on a display of a terminal device and, using pointing means, at least some of the information contents are selected. In response to activating a predetermined message function, a message to be sent is formed from the selected information contents. Address information on the message entered by a user is attached to the message and the formed message is sent to the address defined by the address information. The formed message may be shown in a message editor prior to entering the address information.

### FIELD OF THE INVENTION

The invention relates to sending messages by a terminal device, and particularly to forming a message from information shown on the display of a terminal device.

### BACKGROUND OF THE INVENTION

The fact that various telecommunication systems and communication methods have become more sophisticated and data processing has become increasingly common has resulted in more and more information being delivered electrically. The development of e.g. e-mail, the Internet, and text messages has enabled fast and efficient communication between two different terminal devices, such as a computer or a mobile station.

More and more often, a user of a terminal device is in a situation where the user wishes to send information he or she has browsed or otherwise processed using his or her terminal device to another terminal device. Different procedures have been developed to simplify this function. In Windows™ operating systems, for example, an entire file may be e-mailed by pointing at the icon of the file using a mouse and pressing the right-hand button of the mouse so that a dialogue box opens on the display for the user to select “Send to” and further “Mail recipient”. An e-mail editor whereto the particular file has been attached as an attachment file then opens, and the user is asked to enter the address information on the e-mail. Similarly, in a Nokia™ 9210 Communicator device, a file may be sent by e-mail or through an infrared connection by selecting a file from “File management”, after which “Send” is selected from “Menu” and next, either “As e-mail” or “Via infrared” is further selected.

Instead, forming a message from an opened file or a part thereof typically requires much more procedures. From both the computer environment and “palm computers”, a solution is known for forming a message from an opened file shown on a display wherein a user first, by selecting (“highlighting”), chooses the part of text or another character string from a file the user wishes to attach to the message to be sent, and copies this part onto a “clipboard”. Next, the user is to open a message editor, e.g. an e-mail program or a text message editor, and to attach, using the “Paste” function, the selected text to the text field of the message editor. Next, the message is provided with address information, after which the message is typically ready to be sent.

In other words, in order to form a message from a desired character string, the user is to carry out at least four separate procedures: selecting a character string, copying it, opening a message editor, and attaching the character string to the message editor. Particularly in small portable devices, where one of the most important properties is simplification of functions, such a process is generally considered very laborious and slow as far as usability is concerned. Consequently, a need exists for a simpler way to form a message from a selected character string.

### BRIEF DESCRIPTION OF THE INVENTION

There is now provided a method and an apparatus for implementing the method for simplifying the formation of a message from a file opened by a terminal device. Different aspects of the invention include a method, an electronic device and a computer program, which are characterized by what has been disclosed in the independent claims. Preferred embodiments of the invention are disclosed in the dependent claims.

The idea underlying the invention is that a message is formed from information contents shown on a display of a terminal device by showing, opened, information contents associated with at least one file or information flow on the display of the terminal device and selecting, using pointing means, at least some of the information contents so that in response to activating a predetermined message function, a message to be sent is formed from the selected information contents.

According to an embodiment of the invention, a message is provided with address information on the message entered by the user, and the formed message is sent to the address defined by the address information.

According to an embodiment of the invention, the formed message is shown in a message editor prior to entering the address information.

According to an embodiment of the invention, the message editor to be used is concluded on the basis of the type of the file or the length of the text selected from a part of the file chosen for the message.

According to an embodiment of the invention, the message editor concluded to be the one to be used and the rest of available message editors are shown to the user for acceptance prior to displaying the message in the message editor.

According to an embodiment of the invention, a terminal device is provided with default settings to control the selection of the message editor to be used on the basis of the type of the file or the length of the text selected from a part of the file chosen for the message.

According to an embodiment of the invention, available message editors comprise at least one of the following: a short message editor, a multimedia message editor, an e-mail editor, a fax editor.

According to an embodiment of the invention, a message is provided with default address information, and the formed message is sent to the address defined by the default address information automatically in response to activating a predetermined message function.

According to an embodiment of the invention, the predetermined message function is activated in response to pressing one button or a combination of two or more buttons included in a terminal device.

An advantage of the method and device of the invention is that a single function enables a user to form a message to be sent, the user first having selected the desired part of the information contents shown on a display. This improves the usability of the terminal device, providing a considerable advantage, particularly in small terminal devices. A further advantage is that the user does not need to separately open a message editor to form a message from a character string or a part thereof shown on a display. According to an embodiment, a terminal device comprises default settings, either set by a user or previously programmed in the device, to control the selection of the message editor to be used on the basis of the type of the file or the length of the text selected from a part of the file chosen for the message. An advantage then is that the message to be sent is automatically directed to be sent by the most suitable type of message editor for sending the message. This makes the device faster to use and reduces the number of selections to be made between message editors.

### BRIEF DESCRIPTION OF THE DRAWINGS

The invention is now described in closer detail in connection with the preferred embodiments and with reference to the accompanying drawings, in which

FIG. 1 is a block diagram showing an electronic device to which the invention may be applied; and

FIG. 2 is a flow diagram showing a method according to some embodiments of the invention for forming a message from information shown on a display of a terminal device.

### DETAILED DESCRIPTION OF THE INVENTION

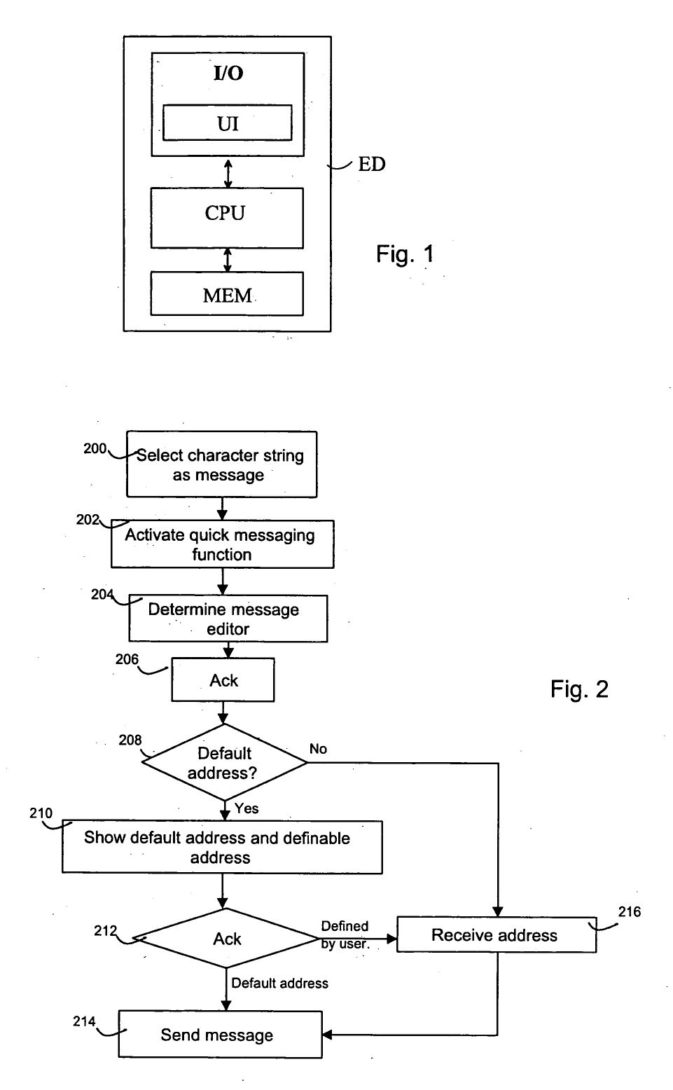

FIG. 1 is a block diagram showing an electronic device (ED), which may be e.g. a wireless mobile station or a PDA device and to which the invention may be applied.

The electronic device (ED) comprises a central processing unit (CPU), a memory (MEM) and an I/O system (I/O). All the necessary information is stored in the memory (MEM) of the device. The memory (MEM) comprises a read-only memory part, which may consist e.g. of a RAM (Random Access Memory) and/or FLASH memory. Through the I/O system (I/O), the device communicates e.g. with other devices, a network and a user. A user interface (UI), which is a part of the I/O system (I/O), comprises an interface necessary for communicating with the user, such as a display, keypad, loud-speaker and/or a microphone. Information obtained from different components of the device is delivered to the central processing unit (CPU), which processes the received information in a desired manner.

The advantages of the invention become more evident when it is used in connection with small, wireless terminal devices, but the invention may also be applied to be used in connection with larger terminal devices, such as computers.

The starting point for the procedure of the invention lies in any file or information flow shown on a display of a terminal device. The file may be e.g. a text file opened or edited by the user of the terminal device he or she wishes to send, completely or partly, to a particular address. The file may also be a WWW page opened by an Internet browser, the user wishing to send a part thereof. The information flow may be e.g. a broadcast or a video data flow to be streamed via a data network. Using the pointing means of the terminal device, the user selects the part of the file he or she wishes to be attached to the message to be sent. Depending on the terminal device, the pointing means of the terminal device may comprise e.g. a mouse, touchscreen stylus, selection carried out using a keypad, or menu-directed pointing. If an entire file is to be attached to a message, the icon of the particular file may be selected from the display or the name of the file may be selected from a file catalogue, for instance. In such a case, the file is attached to the message to be sent primarily as an attachment file.

Next, the user activates a quick message function predetermined in the terminal device. The quick message function is preferably activated by using a special message sending button included in the terminal device, or e.g. by pressing two or more buttons in combination, either simultaneously or in sequence. The button may be implemented as a separate button in the terminal device, or it may be a programmable button (or “soft button”) in connection with the display, which may be provided with various functions, depending on the operating state of the terminal device so that the function being used at a given time is shown as text on the display. The message function may also be implemented as a menu-directed function, but particularly in connection with small communication devices, it is preferable that the activation of the message function may be implemented using as few procedures as possible.

In response to activating the quick message function, a message to be sent is formed from the selected file or a part thereof. In such a case, the message is shown on the display of the terminal device, and the user is asked to provide possible additional definitions for the message as well as an acknowledgement for sending. The message may be shown in a clipboard window of its own so that the additional definitions may comprise the type of the message or the selections of a message editor as well as determination of the address information on the message. Alternatively, the message may be shown directly in a default-value message editor, in which case the additional definitions typically comprise at least determination of the address information on the message.

Several message editors of different type may be available in the terminal device, which is usually capable of sending messages according to several different messaging protocols. A wireless terminal device, such as a mobile station, may be provided with at least a short messaging service (SMS) editor, a multimedia messaging service (MMS) editor, an e-mail editor, and a fax editor.

The message editor to be used may be selected in many different ways. The quick message function may include a setting to conclude the message editor to be used on the basis of the type of the file or the length of the text selected from a part of the file chosen for the message, and to either suggest it to the user for acceptance or to automatically open the particular message editor in response to activating the quick message function. The settings may e.g. determine that short character string messages are to be sent as a short message, small image files as a multimedia message, and an e-mail editor is to be used for large attachment files. Preferably, prior to sending the message, the user is provided with a possibility to change the message editor used for sending the message.

Preferably, it is also possible for the user to provide the terminal device with default settings to control the selection of the message editor to be used on the basis of the type of the file or the length of the text selected from a part of the file chosen for the message. For example, the user may provide a setting to determine that character string messages having less than 160 characters are to be sent using a short message, and that all other messages are to be sent using e-mail.

The formed message may thus first be shown in its own clipboard window, simultaneously also showing to the user for acceptance the message editor concluded to be the one to be used as well as other available message editors prior to showing the message in the message editor. In such a case, in connection with the clipboard window of the message, a list may be shown of available message editors, of which the message editor concluded to be the one to be used is shown in a different way, such as in bold text or with a highlighted background. This enables the user directly at this stage to select the message editor to be used.

The formed message is provided with address information, after which the message is sent to the address defined by the address information. The address information may be attached to the message either prior to selecting the message editor, i.e. already when the formed message is shown in its own window, or not until when showing the message in the message editor to be used. If the address information is entered prior to selecting the message editor, the message editor does not necessarily have to be opened separately on the display of the terminal device for sending the message, but the message may be sent directly to the receiver after the address has been entered and the user has provided an acknowledgement. On the other hand, if the user wishes to edit the message or add something thereto, it is more advantageous to bring the message to a desired message editor; the address information may also be attached at this stage.

The user may also provide the terminal device with default address information, e.g. an e-mail distribution list, in which case in response to pressing a predetermined message sending button or e.g. a combination of several buttons this default address information is attached to the formed message and it is sent automatically to the address defined by the default address information, such as receivers defined in the e-mail distribution list. This enables a desired message to be sent to a given receiver or receivers in a simple manner with one press of a button. According to an embodiment, in response to pressing the message sending button, the particular default-value address and a redefinable address are further shown as alternatives on the display for the user to choose either one.

The sending of the message itself may be implemented using any known communication technology. In connection with wireless terminal devices, such as mobile stations, it is possible to use a short messaging service (SMS), a multimedia messaging service (MMS) or, in the case of e-mail, a mobile station protocol, such as GPRS or HSCSD data transfer, on top of which IP-based e-mail messages are transferred. A mobile station may preferably comprise means for sending messages through an infrared connection or a short-range radio connection, such as a Bluetooth connection, directly to another terminal device.

The practical implementation of the above-described quick message function in a terminal device is preferably carried out at an operating system level so that the operating system reacts to the pressing of the quick message function button or buttons such that a file or a part thereof that was selected in an active application is temporarily copied to the memory to be further attached to a message editor application. The copying itself corresponds to clipboard copying known from various operating systems. Above, several different alternatives have been described to the way in which the message editor to be used is selected and how it is provided with address information; these procedures are to be carried out whenever a selected message is to be sent. In other words, also when the user sends the selected message automatically to the address defined by default address information with one press of a button, the terminal both selects the message editor and provides the message with the address information automatically, even though the user does not see these procedures.

As an aspect of the invention there is provided an electronic device having a display operatively connected thereto, information contents associated with at least one opened file or information flow being configured to be shown on the display; the device comprising pointing means for selecting at least some of the information contents. Such an electronic device comprises means for activating a message function in response to one control command, and means for forming a message from the selected information contents in response to activating the message function. The electronic device may be e.g. a wireless mobile station or a PDA-device according to FIG. 1 or another, preferably small terminal device. The electronic device may also be a larger terminal device, such as a desktop computer or a portable computer, for which the procedure of the invention provides a simpler way to form a message from a file opened by a terminal device. The display may be integrated into the particular electronic device, or it may be a separate display operatively connected to the electronic device, either through a wired or a wireless connection.

FIG. 2 is a flow diagram illustrating some above-described embodiments in a situation wherein a user, using an Internet browser, browses a WWW page and wishes to forward a part of the WWW page. The user selects a desired part of the WWW page (200) by using the pointing means included in the terminal device. Next, the user activates a quick messaging function (202) e.g. by pressing a button associated with the function. As a consequence, the terminal device copies the selected part of the WWW page in memory and starts to determine the message editor to be used (204). Several alternatives have been described above for determining the message editor. In the present example, the selected part of the WWW page is shown in a clipboard window of its own, which is provided with available message editors to be shown therein; in this case e.g. e-mail, highlighted. The user acknowledges some of the available message editors to be used for sending the particular message (206).

Next, the terminal device checks whether or not some default address information has been preset for transmitting the message (208). If some default address information has been set, the terminal device shows it as well as an address redefinable by the user (210) and asks the user to select one or the other (212). If the user selects the default-value address, the message is sent immediately (214) in response to an acknowledgement by the user. If, again, no default address information has been set (208), the terminal device asks the user to enter address information on the message (216). This is also the case when default address information has been set but the user selects (212) the redefinable address. Finally, the message is sent to the address defined by the user (214).

FIG. 2 only shows one example of implementing a quick messaging function in a terminal device. It is obvious to one skilled in the art that the above-described embodiments enable numerous variations of implementing the selection of the message contents by using the pointing means of a terminal device and the selection of the message editor as well as of entering the address into a formed message. At its simplest, the quick messaging function may be implemented, referring to FIG. 2, by selecting the contents of the message (200), activating the quick messaging function (202), and using the default values of the terminal device for determining the message editor (204) and the address (208), on the basis of which the message is sent automatically (214).

The functionality of the invention may be implemented in a terminal device, such as a mobile station, most preferably as a computer program which, when executed in a central processing unit CPU, effects the terminal device to implement procedures of the invention. Most preferably, the computer program may be implemented as a plug-in program to be downloaded into the terminal device or in connection with an application program. Functions of the computer program SW may be distributed to several separate program components communicating with one another. The computer program may be stored in any memory means, e.g. on the hard disk or a CD-ROM disc of a PC, from which it may be downloaded to the memory MEM of a mobile station MS. The computer program may also be downloaded via a network, using e.g. a TCP/IP protocol stack. It is also possible to use hardware solutions or a combination of hardware and software solutions to implement the inventive means.

Consequently, the computer program SW, downloaded into an electronic device, is configured to detect a pointing directed by pointing means to at least one opened file or information flow being shown on the display of the device, the pointing covering at least some of the information contents being shown. Such a computer program product comprises a computer program code part for activating a message function in response to one control command, and a computer program code part for forming a message from a selected file or a part thereof in response to activating the message function.

According to an embodiment, the computer program product comprises a computer program code part for attaching, to a message, address information on the message entered by a user, and a computer program code part for sending the formed message to the address defined by the address information.

It is obvious to one skilled in the art that as technology advances, the basic idea of the invention can be implemented in many different ways. The invention and its embodiments are thus not restricted to the above-described examples but may vary within the scope of the claims.

1. A method of forming a message from information contents shown on a display, the method comprising:
showing, opened, information contents associated with at least one file or information flow on a display of a terminal device;
selecting, using pointing means, at least some of the information contents;
forming, in response to activating a predetermined message function, a message to be sent from the selected information contents.

2. A method as claimed in claim 1, further comprising
attaching to the message address information entered by a user; and
sending the formed message to the address defined by the address information.

3. A method as claimed in claim 2, further comprising
showing the formed message in a message editor prior to entering the address information.

4. A method as claimed in claim 3, further comprising
concluding the message editor to be used on the basis of the type of the file or the length of the text selected from a part of the file chosen for the message.

5. A method as claimed in claim 4, further comprising
showing the message editor concluded to be the one to be used and other available message editors to the user for acceptance prior to showing the message in the message editor.

6. A method as claimed in claim 3, further comprising
providing the terminal device with default settings to control the selection of the message editor to be used on the basis of the type of the file or the length of the text selected from a part of the file chosen for the message.

7. A method as claimed in claim 3, wherein
the available message editors comprises at least one of the following: a short message editor, a multimedia message editor, an e-mail editor, a fax editor.

8. A method as claimed in claim 1, further comprising
attaching default address information to the message; and
sending the formed message to the address defined by the default address information automatically in response to activating the predetermined message function.

9. A method as claimed in claim 1, further comprising
activating the predetermined message function in response to pressing one button or a combination of two or more buttons included in the terminal device.

10. An electronic device having a display operatively connected thereto, information contents associated with at least one opened file or information flow being configured to be shown on the display; the device comprising
pointing means for selecting at least some of the information contents;
means for activating a message function in response to one control command; and
means for forming a message from the selected information contents in response to activating the message function.

11. A device as claimed in claim 10, wherein
the device comprises means for attaching address information entered by a user to the message; and
means for sending the formed message to the address defined by the address information.

12. A device as claimed in claim 11, wherein
the device is configured to show the formed message in a message editor prior to entering the address information.

13. A device as claimed in claim 12 wherein
the device comprises means for concluding the message editor to be used on the basis of the type of the file or the length of the text selected from a part of the file chosen for the message.

14. A device as claimed in claim 13, wherein
the device is configured to show the message editor concluded to be the one to be used and other available message editors to the user for acceptance prior to showing the message in the message editor.

15. A device as claimed in claim 12, wherein
the device comprises means for providing the terminal device with default settings to control the selection of the message editor to be used on the basis of the type of the file or the length of the text selected from a part of the file chosen for the message.

16. A device as claimed in claim 12, wherein
the available message editors comprise at least one of the following: a short message editor, a multimedia message editor, an e-mail editor, a fax editor.

17. A device as claimed in claim 10, wherein
the device comprises means for attaching default address information to the message; and
means for sending the formed message to the address defined by the default address information automatically in response to activating a predetermined message function.

18. A device as claimed in claim 10, wherein
the device comprises means for activating the predetermined message function in response to pressing one button or a combination of two or more buttons included in the terminal device.

19. A computer program product which, when downloaded into an electronic device, is configured to detect a pointing directed by pointing means to at least one opened file or information flow being shown on a display of the device, the pointing covering at least some of the information contents, the computer program product comprising
a computer program code part for activating a message function in response to one control command; and
a computer program code part for forming a message from the selected information contents in response to activating the message function.

20. A computer program product as claimed in claim 19, further comprising
a computer program code part for attaching address information on a message entered by the user to the message; and
a computer program code part for sending the formed message to the address defined by the address information.

21. A computer program product as claimed in claim 19, further comprising
a computer program code part for activating the message function in response to pressing one button or a combination of two or more buttons included in the terminal device.
